(19) United States
(12) Patent Application Publication
(10) Pub. No.: US 2003/0020330 A1
(43) Pub. Date: Jan. 30, 2003

(54) DC ladder bus

(76) Inventors: William E. Cratty, Bethel, CT (US); Derek W. Fletcher, Wooton-under-edge (GB)

Correspondence Address: CANTOR COLBURN LLP, 55 Griffin Road South, Bloomfield, CT, 06002, US

(21) Appl. No.: 10/186,768

(22) Filed: Jul. 1, 2002

Related U.S. Application Data
(60) Provisional application No. 60/304,883, filed on Jul. 12, 2001.
(60) Provisional application No. 60/345,328, filed on Jan. 4, 2002.

(51) Int. Cl. H02J 1/00

(52) U.S. Cl. 307/8

(57) ABSTRACT

An embodiment of the invention is a DC ladder bus having a first positive DC rail and a first negative DC rail defining a first DC bus rail for carrying DC power. A second positive DC rail and a second negative DC rail defined a second DC bus rail carrying DC power. A plurality of rungs are coupled across the first DC bus rail and the second DC bus rail. A generator is coupled to each rung. A plurality of disconnects are associated with each of the rungs to individually isolate each of the rungs from one of the first DC bus rail and the second DC bus rail.

### CROSS-REFERENCE TO RELATED APPLICATIONS

This application claims the benefit of U.S. provisional patent application No. 60/304,883 filed Jul. 12, 2001, the entire contents of which are incorporated herein by reference, and claims the benefit of U.S. provisional patent application No. 60/345,328 filed Jan. 4, 2002, the entire contents of which are incorporated herein by reference.

### BACKGROUND OF THE INVENTION

The invention relates in general to power systems and in particular to a DC ladder bus structure for distributing power. Power distribution systems may utilize a DC bus to distribute electrical power. Such a distribution system is described in published PCT application WO 01/93410. The use of a DC bus provides advantages such as eliminating the need for phase synchronization between power sources and with loads that is needed for AC power.

One drawback to existing DC bus architectures is a lack of flexibility. In certain DC bus systems, expanding or contracting the bus requires shutting down the bus. In addition, maintenance of the bus may require shutting down the bus. Depending on whether alternate power arrangements exist, this may interrupt power to the loads. A DC bus architecture that is flexible to scalability and maintenance without interrupting power to the loads is needed.

### SUMMARY OF THE INVENTION

An embodiment of the invention is a DC ladder bus having a first positive DC rail and a first negative DC rail defining a first DC bus rail for carrying DC power. A second positive DC rail and a second negative DC rail defined a second DC bus rail carrying DC power. A plurality of rungs are coupled across the first DC bus rail and the second DC bus rail. A generator is coupled to each rung. A plurality of disconnects are associated with each of the rungs to individually isolate each of the rungs from one of the first DC bus rail and the second DC bus rail.

### BRIEF DESCRIPTION OF THE DRAWINGS

Referring now to the drawings wherein like elements are numbered alike in the several Figures.

FIG. 1 is a block diagram of an exemplary power distribution system utilizing a DC bus.

FIGS. 2A-2D are a block diagram of an exemplary DC ladder bus in an embodiment of the invention.

FIGS. 3A and 3B are a block diagram of an exemplary DC ladder bus in an alternate embodiment of the invention.

FIG. 4 is a block diagram of an exemplary DC ladder bus in an alternate embodiment of the invention.

### DETAILED DESCRIPTION

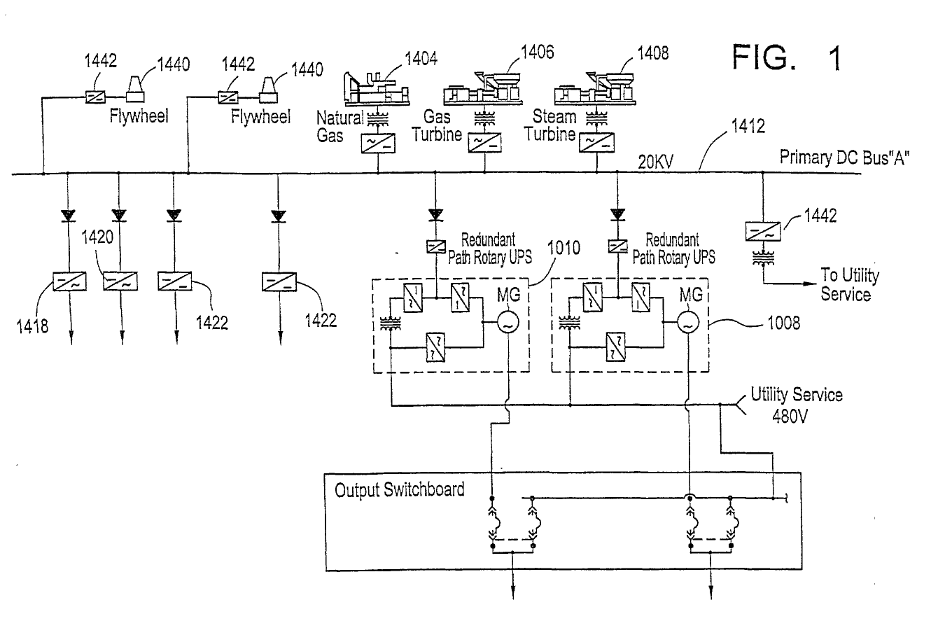

The invention is directed to a DC ladder bus structure used to distribute power. FIG. 1 depicts an exemplary power system where the DC ladder bus may be employed. Additional DC bus architectures are disclosed in PCT application WO 01/93410, the entire contents of which are incorporated herein by reference.

FIG. 1 depicts a DC bus 1412 coupled to a variety of power sources including rotary flywheels 1440 coupled to DC bus 1412 through AC/DC converters 1442. Other power sources include natural gas generator 1404, gas turbine 1406 and steam turbine 1408. Other power sources such as fuel cells, public utilities, batteries, etc. may be coupled to the DC bus 1412.

The DC bus 1412 serves as a distribution point for various loads through a variety of power conditioning devices. One load requiring 480 VAC is supplied through DC/AC converter 1418 having an input coupled to the DC bus 1412. A load requiring 13.8 KVAC is supplied through DC/AC converter 1420 having an input coupled to the DC bus 1412. Loads requiring 48V DC (such as telecommunications equipment) are supplied through DC/DC converters 1422 having inputs coupled to the DC bus 1412. Power conditioning devices 1418, 1420 and 1422 are solid state devices, but rotary power conditioning devices 1008 and 1010 may also be connected to DC bus 1412. Rotary devices 1008, 1010 may be implemented by un-interruptible power systems (UPS). A suitable UPS is the Uniblock-11 brand sold by Piller. The rotary devices 1008 and 1010 feed an output switchboard to other loads. The DC bus 1412 may also back-feed the utility service through a DC/AC converter 1442.

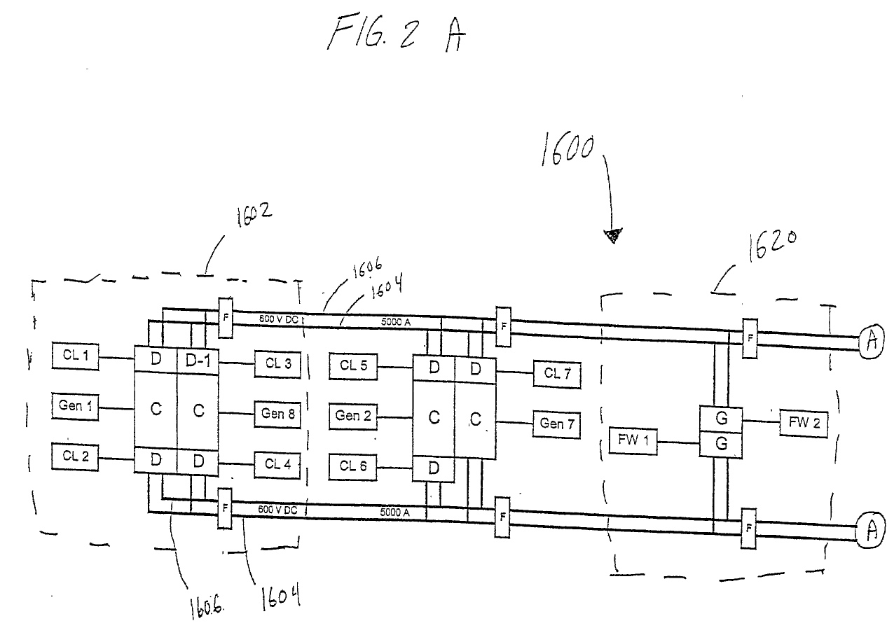

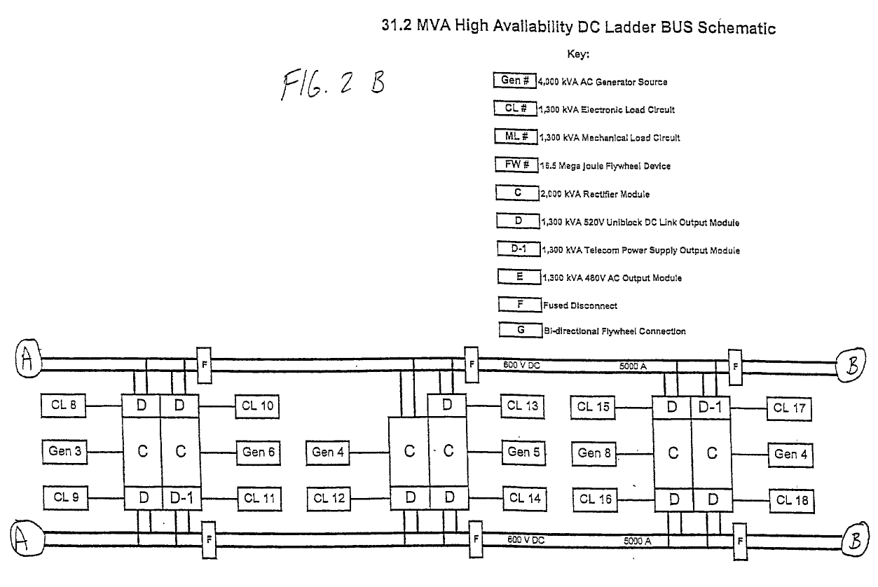

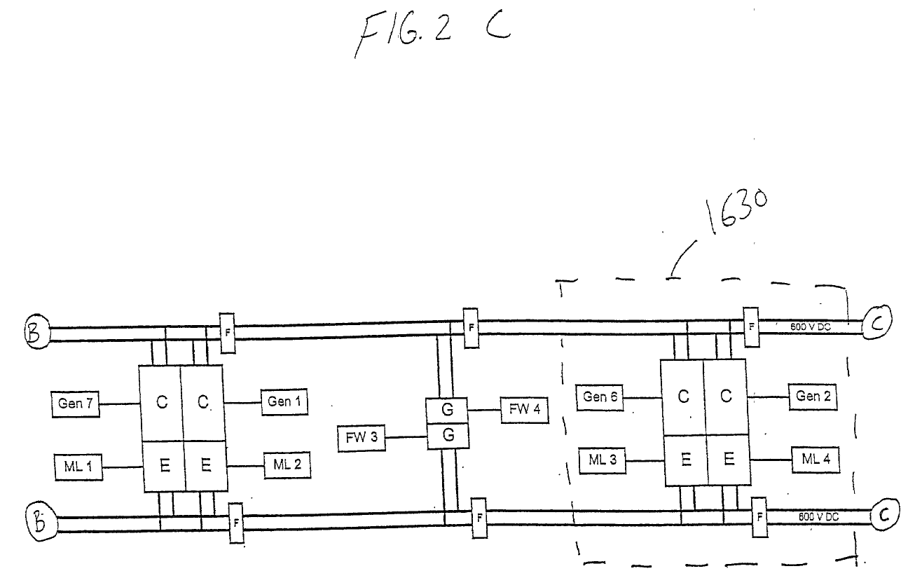

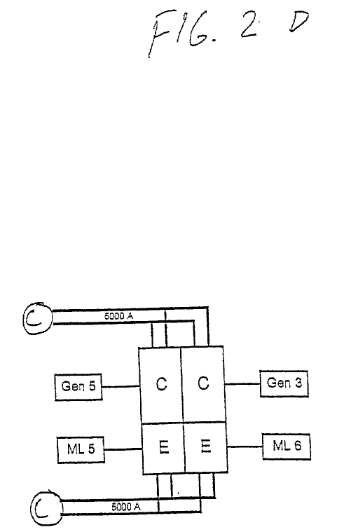

FIGS. 2A-2D depict an exemplary DC bus 1600 architecture that may be used to implement DC bus 1412. The DC bus 1600 has an architecture referred to as a ladder where separate rungs are connected in parallel between pairs of positive and negative rails. For example, as shown in FIG. 2A, a rung 1602 is connected across pairs of positive rails 1604 and negative rails 1606. Rung 1602 is powered by generators Gen 1 and Gen 8 that feed power conditioning devices such as rectifiers C. From rectifiers C, various power conditioning devices such as rotary devices D (e.g., a Uniblock brand UPS) and telecommunications power supply D-1 (e.g., +−48 V DC) are used to provide power to loads CL1, CL2, CL3, and CL4. Rung 1602 may be disconnected from the pairs of rails 1604 and 1606 through disconnects F. Disconnects F serve as switches to isolate sections of the DC ladder bus and then reconnect these sections.

Another rung 1620 includes flywheels FW1 and FW2 and bi-directional connections G. If a step load is applied to the DC bus 1600 (e.g., a compressor turns on) the flywheels may be used to provide interim power while a generator responds to the load. Conversely, if a load is quickly removed from the bus 1600 (e.g., the compressor turns off), excess power may be fed through bi-directional connections G to flywheels FW1 and FW2 to increase energy storage of the flywheel. Other types of energy storage devices may be used instead of flywheels. Again, rung 1620 includes disconnects F to isolate rung 1620 for service, upgrades, etc.

Rung 1630 in FIG. 2C includes power conditioning devices in the form of AC output modules E which provide AC power to mechanical loads ML3 and ML4.

The bus architecture of FIGS. 2A-2D provides many advantages. The bus 1600 has no single point of failure and thus, is fault tolerant. Bus 1600 features dual DC bus rails (each including a positive rail 1604 and a negative rail 1606) and a redundant array of independent input and output devices. Each rung is powered by at least two generators, and no two rungs are powered by the same combination of generators. This redundancy provides no single point of failure.

The bus 1600 can be scaled up by adding additional rungs or down by removing rungs through disconnects F without disturbing the remainder of the bus. In an exemplary embodiment, the bus 1600 provides standard 600 volt, 5,000 amp DC power. The module design of rungs connected in parallel with different components provides for varying kW capacities for larger and smaller systems. The ladder design also provides for multiple inputs from a large power source to be distributed evenly along the bus. The ladder design provides ability to isolate a rung for maintenance without disrupting functioning of other rungs through disconnects F.

The ladder design uses modular power conditioning devices such as rectifier C, DC links D and D-1 and AC output module E to provide flexibility to combine a variety of input and output devices in the same system. The bus can incorporate any AC power supply (generators, utility services, etc.) regardless of Hz along with a DC power supply such as a fuel cell. The bus can also incorporate various AC output devices such as conventional inverters and variable speed motor drives along with DC output devices such as a disconnect to feed the DC link of the Uniblock rotary motor generator or a converter to feed −48V power to telecom switches.

The use of flywheels FW helps stabilize DC bus voltage by absorbing instantaneous power surges caused by rotary inertia of on-site generation when large loads are taken off line and supplying power to prevent voltage sags during large instantaneous step loads.

As described above, a variety of power conditioning devices may be used to transfer power from the DC bus to the load. Rotary devices, such as a motor-generator, may be coupled to the DC bus to provide high reliability power to critical loads. Alternatively, solid state devices such as DC/AC converters or DC/DC converters may be coupled to the DC bus to provide power to loads requiring less reliable power. Additional power sources can be easily added to the DC bus given the simplicity in coupling DC sources in parallel. The ability to add additional power sources to the DC bus and couple the DC bus to a variety of types of loads provides a flexible power system that can adapt to changing power requirements.

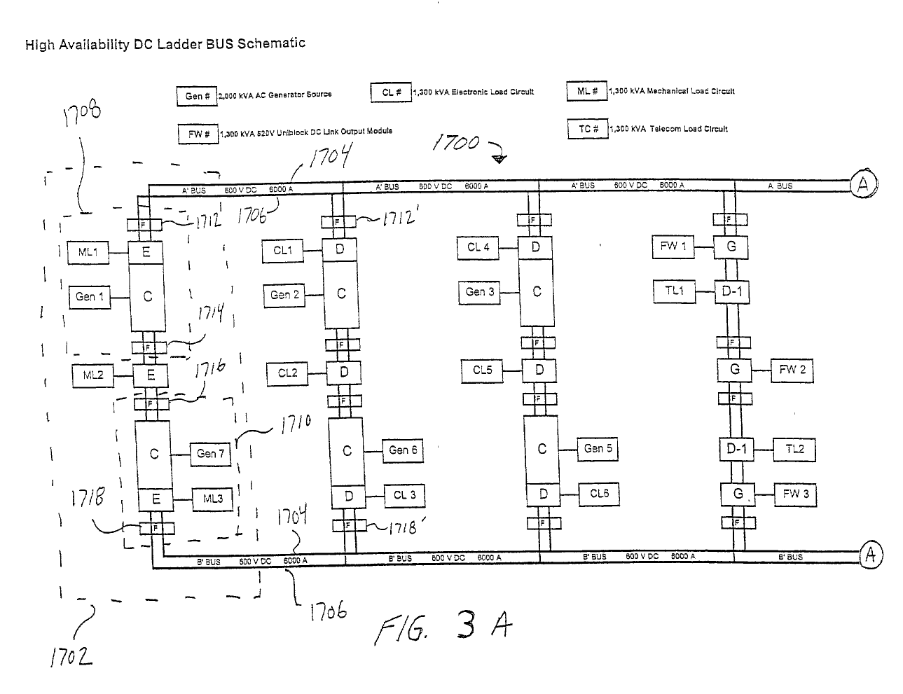

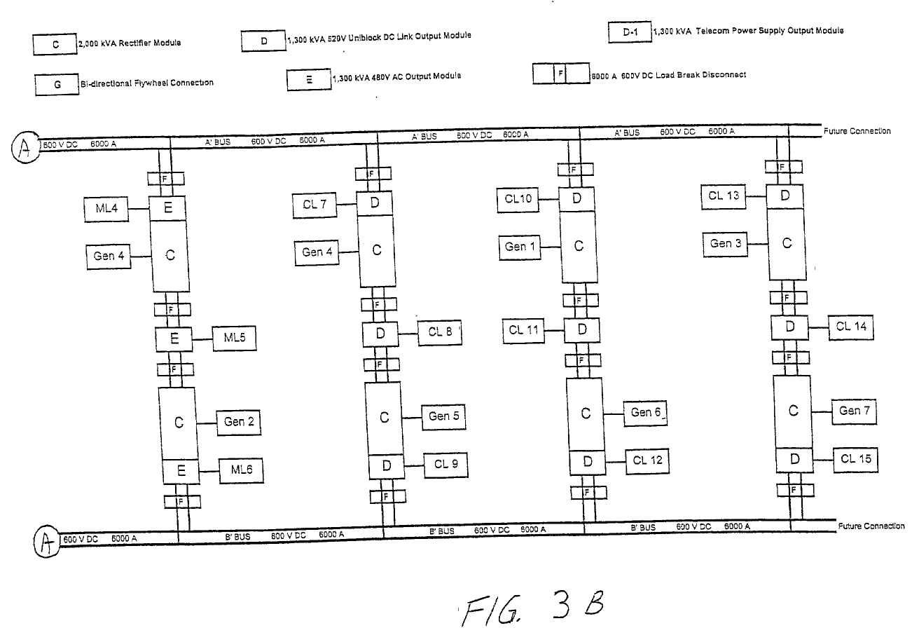

As noted above, the power sources employed are not limited and may include fuel cells, generators, utility power, micro-turbines, turbines, reciprocating engines and other types of power sources, and combinations of different types of power sources. FIGS. 3A-3B depict an exemplary alternate DC bus architecture that may be used to implement a single DC bus 1700. The DC bus 1700 may be used in a variety of applications such as bus 1412 depicted in FIG. 1. The DC bus 1700 has an architecture referred to as a ladder where separate rungs are connected in parallel between dual positive and negative rails. For example, as shown in FIG. 3A, a rung 1702 is connected across pairs of positive rails 1704 and negative rails 1706.

Components in FIGS. 3A-3B are similar to those described above with reference to FIGS. 2A-2D. In the embodiment shown in FIGS. 3A and 3B, each rung portion includes two internal disconnects F (1714 and 1716) so that a portion of a rung may be isolated. For example, in rung 1702, rung portion 1708 coupled to generator Gen 1, may be isolated by opening disconnect 1712 and opening internal disconnect 1714. Rung portion 1710 coupled to generator Gen 2 may be isolated by opening internal disconnect 1716 and opening disconnect 1718. Additionally, an entire DC bus rail (positive/negative rail pair) may be disconnected from the rungs by opening disconnects 1712, 1712′, etc. across all rungs.

In normal operation the total load on the ladder bus 1700 is shared equally between the generator inputs. However if inputs from individual generators are not available, the load is shared equally between the remaining generator inputs and distributed through the rails 1704 and 1706 of the ladder bus into the rungs as required. The location of the disconnects F enables each rung to be isolated. Each generator Gen input with its associated power conditioning output device can be isolated individually, maintaining one generator input and two power conditioning output devices on each rung.

A pair of positive and negative rails, 1704 and 1706 can be isolated allowing extension rails and rungs to be added to extend the ladder allowing the system to continue to operate normally whilst the extensions rails and rungs are added. In other words, rails 1704 and 1706 shown as the DC bus rail (A bus) can be isolated by opening disconnects 1712, 1712′, etc. Once isolated, an extension to the DC bus rail can be added and/or a new rung can be connected to the A bus. The first DC bus rail (depicted as A bus) made up of rails 1704 and 1706 may then be reconnected through disconnects 1712, 1712′, etc. The second DC bus rail (depicted as B bus) could then be isolated, connected to a similar rail extension and/or a new rung, and reconnected.

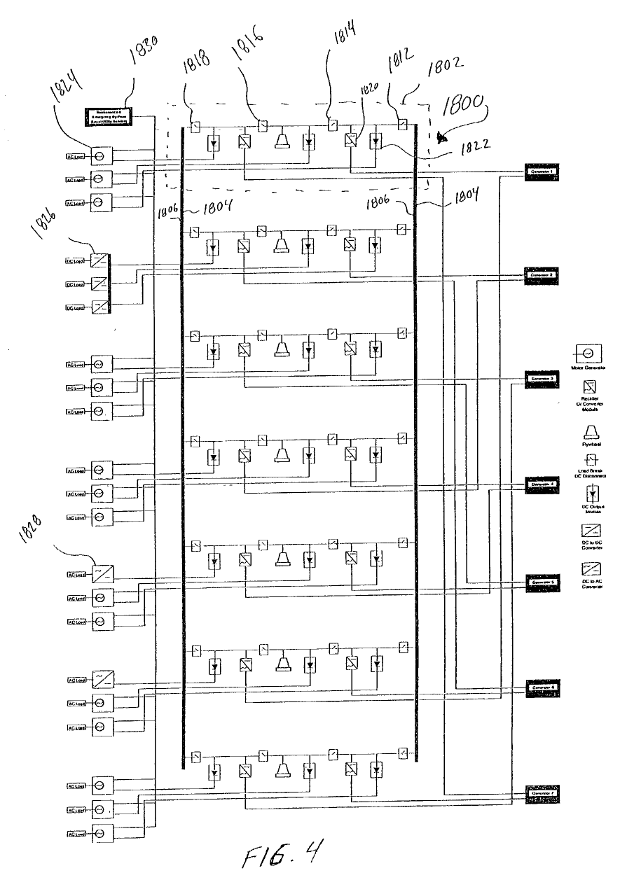

FIG. 4 depicts a DC ladder bus 1800 in an embodiment similar to that of FIG. 3. The bus 1800 includes rungs 1802 coupled between pairs of positive rails 1804 and negative rails 1806. In rung 1802, disconnects 1812, 1814, 1816 and 1818 allow rung 1802 to be disconnected from either DC bus rail and allow portions of the rung to be isolated as well.

Generators 1-7 are connected to rungs 1802 through power conditioning devices such as AC/DC rectifier or DC/DC converter 1820 depending on the output of the generator. The output from the rung 1802 is provided to loads through an output power conditioning devices such as DC output module 1822 and coupled to loads through a motor generator 1824, a solid-state DC/DC converter 1826 or a solid-state DC/AC converter 1828 depending on the type of load (AC or DC). An alternator power source (e.g., utility) 1830 may be used as an emergency bypass in the event the DC bus is unavailable.

FIG. 4 also depicts the redundancy of the generators. Each rung is power by two generators and each rung is powered by a different combination of generators. In the event that a generator fails, the generator redundancy ensures that each rung of the DC bus 1800 receives power.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A DC ladder bus comprising:
a first positive DC rail and a first negative DC rail defining a first DC bus rail for carrying DC power;
a second positive DC rail and a second negative DC rail defining a second DC bus rail carrying DC power;
a plurality of rungs, each rung coupled across the first DC bus rail and the second DC bus rail;
a generator coupled to each rung; and
a plurality of disconnects, each disconnect associated with one of said rungs to individually isolate each of said rungs from one of said first DC bus rail and said second DC bus rail.

2. The DC ladder bus of claim 1 wherein:
each rung includes a first disconnect connecting said rung to said first DC bus rail and a second disconnect connecting said rung to said second DC bus rail.

3. The DC ladder bus of claim 2 wherein:
each rung includes a first internal disconnect for disconnecting a first portion of said rung from a second portion of said rung; and,
each rung includes a second internal disconnect for disconnecting a second portion of said rung from said first portion of said rung.

4. The DC ladder bus of claim 1 wherein:
said generator includes a plurality of generators, each rung receiving power from at least two generators.

5. The DC ladder bus of claim 4 wherein:
each rung receives power from two generators and each rung receives power from a different combination of generators.

6. The DC ladder bus of claim 4 further comprising:
a power conditioning device connecting said generator to at least one of said rungs.

7. The DC ladder bus of claim 6 wherein:
said power conditioning device includes a DC/DC converter.

8. The DC ladder bus of claim 6 wherein:
said power conditioning device includes an AC/DC converter.

9. The DC ladder bus of claim 1 wherein:
said generator includes a flywheel.

10. The DC ladder bus of claim 1 further comprising:
at least one load coupled to one of said rungs;
said load connected to one of said rungs through an output power conditioning device.

11. The DC ladder bus of claim 10 wherein:
said output power conditioning device is a solid state DC/DC converter.

12. The DC ladder bus of claim 10 wherein:
said output power conditioning device is a solid state AC/DC converter.

13. The DC ladder bus of claim 10 wherein:
said output power conditioning device is a rotary device

14. A DC ladder bus comprising:
a first positive DC rail and a first negative DC rail defining a first DC bus rail for carrying DC power;
a second positive DC rail and a second negative DC rail defining a second DC bus rail carrying DC power;
a plurality of rungs, each rung coupled across the first DC bus rail and the second DC bus rail;
a generator coupled to each rung; and
a plurality of disconnects, each disconnect associated with one of said rungs to individually isolate each of said rungs from one of said first DC bus rail and said second DC bus rail;
wherein each rung includes a first disconnect connecting said rung to said first DC bus rail, a second disconnect connecting said rung to said second DC bus rail, a first internal disconnect for disconnecting a first portion of said rung from a second portion of said rung and a second internal disconnect for disconnecting a second portion of said rung from said first portion of said rung;
said generator includes a plurality of generators, each rung receiving power from two generators and each rung receives power from a different combination of generators.
